(19) United States
(12) Patent Application Publication
(10) Pub. No.: US 2003/0007485 A1
(43) Pub. Date: Jan. 9, 2003

(54) Method and system for operating an edge router

(75) Inventors: Narayanan Venkitaraman, Hoffman Estates, IL (US); Jayanth Pranesh Mysore, Hoffman Estates, IL (US); Stephen P. Emeott, Rolling Meadows, IL (US)

Correspondence Address: MOTOROLA, INC., 1303 EAST ALGONQUIN ROAD, IL01/3RD, SCHAUMBURG, IL, 60196

(73) Assignee: MOTOROLA, INC

(21) Appl. No.: 09/862,379

(22) Filed: May 22, 2001

(51) Int. Cl. G06F 9/00; H04L 12/56; H04L 12/28

(52) U.S. Cl. 370/389

(57) ABSTRACT

A method for operating an edge router in a network that provides multiple levels of service is provided. In response to receiving packets, the edge router determines a corresponding packet flow. An incremental utility for each packet is then calculated, and each packet is labeled as a function of the incremental utility. The packets are then forwarded to core routers in the network, where they are processed based on the labels. The incremental utility can be based on a utility function corresponding to the flow and intra-flow priorities associated with the packets.

### RELATED APPLICATIONS

This application is related to U.S. patent application Ser. No. _/_____, Attorney Docket No.: CR00251M entitled “Method and System for Operating a Core Router”, filed on even date herewith and assigned to the same assignee, the subject matter of which is hereby incorporated by reference.

### FIELD OF THE INVENTION

The present invention relates to network routers, and, more particularly, to a method and system for operating an edge router within a high-speed network.

### BACKGROUND OF THE INVENTION

The Internet is increasingly being used for a multitude of applications and services, including, for example, video conferencing, remote video applications, Internet telephony and many other similar applications and services. Most of these applications and services are typically long-lived; that is, they last for several minutes or hours. Additionally, these applications and services are adaptive. That is, they can operate over a wide range of bandwidths with different levels in the perceived quality of the applications or service. This adaptation requirement is becoming increasingly important with the deployment of multicasting, as well as the use of mobile devices. However, widespread use of the Internet for such resource-sensitive flows is stymied by the Internet's inability to provide any commitments concerning the quality of service that a flow can receive.

There have been two standardized approaches for providing an end-to-end quality of service for flows within the Internet. An earlier approach, Integrated Services, or “Intserv”, as proposed in Wroclawski, “Specification of the Controlled-Load Network Element Service,” RFC 2211, September, 1997 (hereinafter referred to as “Wroclawski”); Shenker and Patridge, “Specification of Guaranteed Quality of Service,” RFC 2212, September, 1997 (hereinafter referred to as “Shenker I”); and Shenker and Wroclawski, “General Characterization Parameters for Integrated Service Network Elements,” RFC 2215, September, 1997 (hereinafter referred to as “Shenker II”), all of the contents of which are fully made a part of this specification and fully incorporated herein, proposed a comprehensive model for providing service commitments on a per-flow basis. While the commitments were strict, the routers were required to maintain per-flow state information. However, this is not a scalable approach in core routers that are characterized by very high speeds and a large number of flows.

A second approach, referred to as Differentiated Services, or “Diffserv”, as proposed in Blake, et al., “A Framework for Differentiated Services,” Internet Draft, October 1998 (hereinafter referred to as “Blake”), the contents of which are fully made a part of this specification and fully incorporated herein, proposes a model which maintains simplicity in the core router, and defines new roles for the edge routers into network domains. However, this model supports a much coarser notion of a quality of service for flows. In fact, the model can make no quantitative guarantees on a per-flow basis. Furthermore, the efficacy of a Diffserv-based quality of service solution will most likely rely heavily on engineering the network appropriately, and the scale of the number of flows will have a significant dependence on the degree of provisioning required to deliver a given quality of service to the flows using the network. Though over-provisioning has been a viable solution for a telephone network, it is neither effective nor efficient for data networks. Refer to Shenker, “Fundamental Design Issues for the Future Internet,” IEEE JSAC, Vol. 13, No. 7, September, 1995 (hereinafter referred to as “Shenker III”), the contents of which are fully made a part of this specification and fully incorporated herein.

More recently, Core-Stateless Fair Queuing (CSFQ), as presented in Stoica, Shenker and Zhang, “Core-Stateless Fair Queuing: Achieving Approximately Fair Bandwidth Allocations in High Speed Networks”, Proceedings of the ACM SIGCOMM '98Conference, September, 1998 (hereinafter referred to as “Stoica I”); DPS, as presented in Stoica and Zhang, “Providing Guaranteed Services Without Per-flow Management,” Proceedings of the ACM SIGCOMM '99Conference, September, 1999 (hereinafter referred to as “Stoica II”); Corelite, as presented in R. Sivakumar, T. Kim, N. Venkitaraman, and V. Bharghavan, “Achieving Per-flow Weighted Fairness in a Core-Stateless Network,” Proceedings of the ICDCS Conference 2000, April, 2000 (hereinafter referred to as “Sivakumar”); and Rainbow Fair Queuing(as presented in Zhiruo Cao, Zheng Wang and Ellen W. Zegura, “Rainbow Fair Queuing: Fair Bandwidth Sharing Without Per-Flow State,” Proceedings of the IEEE Infocomm conference 2000, March, 2000(hereinafter referred to as “Zhiruo”), all of the contents of which are fully made a part of this specification and fully incorporated herein, have proposed mechanisms for maintaining per-flow service commitments without maintaining per-flow state measurement information in the core routers. These approaches aim to provide one or more of the services provided by Intserv without compromising on the complexity of the core router, hence making them scalable.

However, although the above approaches are useful in some circumstances, none of the above approaches provides for intra-flow priorities to enable flows to make optimal use of the allocated network resources, where optimal use maximizes aggregate utility, even as the allocations vary within a user specified utility function, which defines the utility a user derives for various amounts of resource allocations. It would be desirable to have a method and system for operating an edge router that overcomes the above-discussed disadvantage.

### BRIEF DESCRIPTION OF THE DRAWINGS

FIG. 1 illustrates sample utility functions in accordance with the present invention;

FIG. 2 illustrates examples of bandwidth allocation in a network;

FIG. 3 illustrates a block diagram of a network in accordance with the present invention;

FIG. 4 illustrates a graphical representation of the threshold utility as a function of the incremental utility and output link capacity;

FIG. 5 illustrates a flowchart of a method for operating a core router; and

FIG. 6 illustrates a flowchart of a method of operating an edge router in accordance with the present invention.

### DETAILED DESCRIPTION OF THE PRESENTLY PREFERRED EMBODIMENTS

The present invention proposes a unique framework and algorithm for operating an edge router, and, more specifically, for marking a packet at an edge router prior to sending it to a packetized queue in a router.

A system in accordance with the present invention uses an approach similar to that disclosed in Stoica I, above. However, the systems and methods disclosed herein additionally satisfy the following principles.

First, the utility (i.e., the satisfaction) that a user may derive as a result of an incremental allocation of bandwidth varies depending upon that user's preferences and the nature of the application in use. This principle is based on the widespread use of layered streaming (as presented in McCanne, Van Jacobson and Vetterli, “Receiver-Driven Layered Multicast,” Proc. SIGCOMM '96, August, 1996, pp. 117-130 (hereinafter referred to as “McCanne”), as well as generally used encoding methods, including, for example, MPEG (as described in ISO/IEC International Standard: ISO/IEC 11172, “Information technology—Coding of moving pictures and associated audio for digital storage media at up to about 1.5 Mbit/s”).

Second, the present invention may be used to accomplish the goal of maximizing the satisfaction of the users sharing any link of the network. Finally, it overcomes the impracticality in maintaining per-flow state in core routers, due to both the immense processing time and memory required by the core router.

As a result, the system and method disclosed herein include the following features. First, the system exposes an adaptive service model; i.e., a model that allows applications to specify an allocation-derived utility function. This utility function is derived as a function of the resource allocated. Second, the system allows flows to indicate different priority levels within that particular flow. Third, the system maximizes the aggregate utility (i.e., satisfaction) of the users sharing any given link within the network. Fourth, the system provides for service differentiation across flows. Furthermore, this provision is achieved without compromising the forwarding efficiency of the core router or maintaining a per-flow state information. Finally, the system allows for the realization of different service models using the same network architecture.

The system achieves this by allowing for configuration of the entities accordingly. For example, fair (equal) allocation of resources to all the users can be achieved by having the same (concave) utility function for all the users in the system.

From an individual flow perspective, it is preferable that a service model be flexible enough to specify its requirements clearly and completely to the user. From a network perspective, the service model should enable the network to differentiate between flows easily and enable the network to allocate its resources in an optimal method. Such is one of the objects of the algorithm of the present invention. Flows may derive different amounts of user satisfaction for every incremental allocation of bandwidth. This is especially true for multimedia applications (either in scalable or multi-rate encoding formats) that can operate at different bandwidths, and with different levels of quality and satisfaction. Additionally, the relative user satisfaction value may also depend on the relative importance of the flow in the group of flows sharing the link.

One way for a flow to indicate to the network the satisfaction the user derives out of incremental allocations of bandwidth is through the use of utility functions. A utility function quantifies the usefulness (i.e., satisfaction) that a flow provides its user if the flow is allocated (or limited to) a certain quantum of a resource. The utility function also maps the range of operational points of a flow to the utility that the user derives at each point.

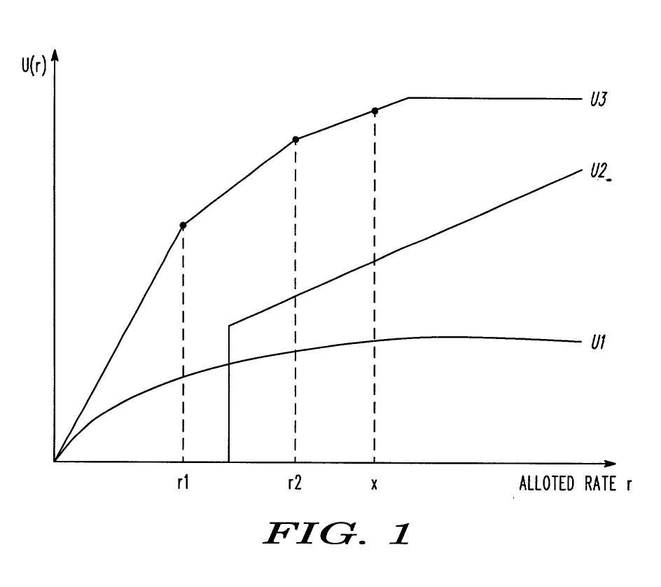

FIG. 1 shows various sample utility functions. Such utility functions, as those shown in FIG. 1, provide the necessary flexibility to allow flows to fully express and realize arbitrarily (or user) defined requirements. The assignment of utility functions to flows also allows the network operator to provide different service classes.

A utility function is just one possible paradigm for communicating a flow's (or a user's) resource preferences to the network. Although the algorithm of the system concentrates on utility functions, a framework realizing the same goals and objects equivalent to the system may be deployed using any other mechanism for indicating a packet's (or user's) priority to the network.

Assuming that most flows provide the network with utility functions, the network operator can then use the utility function of each flow to realize various objectives of the network. Preferably, there are at least two possible objectives. First, the network operator may desire to maximize the aggregate utility at every link in the network. That is, at every link in the network, the network operator maximizes the function ΣUᵢ(rᵢ), i=1 to M, subject to the constraint Σrᵢ≦C, i−1 to M, where M is the number of flows sharing the link, Uᵢ(rᵢ), is the utility function derived by the flow, i, for an allocation, rᵢ, and C is the total link capacity. Second, the network operator may desire to maximize the aggregate system utility. That is, to maximize ΣUᵢ(rᵢ), i=1 to N, where N is the total number of flows in the network.

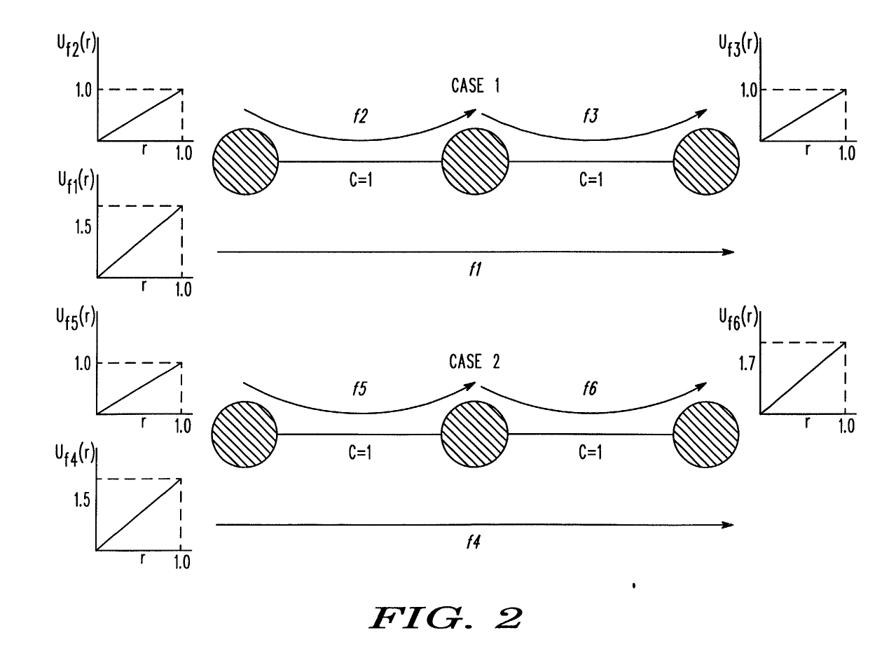

In networks with a single link, both the above stated objectives are equivalent. However, for a multi-hop network, the objectives are not the same. For instance, consider the example shown in Case 1 of FIG. 2. In FIG. 2, f1 includes a high priority flow and, as a result, has a larger incremental utility function than that for f2 and f3. If the available bandwidth is one unit, and the network operator elects to utilize the first objective function, one unit is allocated to f1 in both the links. This maximizes the aggregate utility at every link in the network. The resultant total system utility is 1.5. However, using the function as detailed in the second objective, above, the network operator allocates one unit to f2 and to f3. Therefore, though the utility at any given link in FIG. 2 is only 1.0, the resultant total system utility is 2.0. This difference results from the method in which the utility function is interpreted. For instance, assuming the utility functions represent the relative priorities of different flows (or different parts of a flow), then the first objective function would be appropriate because it provides an allocation that maintains the relative priorities of the flows at each link in the network. The system operation, as described in the algorithm below, is targeted to providing for this allocation. Additionally, considering the example illustrated in Case 2 of FIG. 2, the optimal allocation targeted by this invention would be to allocate one unit of bandwidth to f5 and to f6. This problem, which is also satisfied by the system, can therefore be defined as a weighted version of the maximum-minimum fair resource allocation, with the weights being a function of the flow's incremental utility functions.

To satisfy the service model proposed in the previous section, at least three different approaches exist. First, a centralized approach exists. In this approach, the flows supply a centralized server with the utility functions of the flows. As a result, the centralized server maintains complete knowledge about the topology of the network, as well as the routes of the flows contained within the system. Such a centralized server can then compute the allocations to be made to the flows by recursively applying an algorithm for allocation over a single link. The second proposal involves a partially distributed approach in which every node in the network operates a centralized algorithm over each of the node's output links.

The third approach is fully distributed, and based the same philosophy used in technologies such as, for example, those described in Stoica II and Sivakumar, above. Furthermore, in the third approach, the result is scalable and does not affect the forwarding efficiency of the core routers.

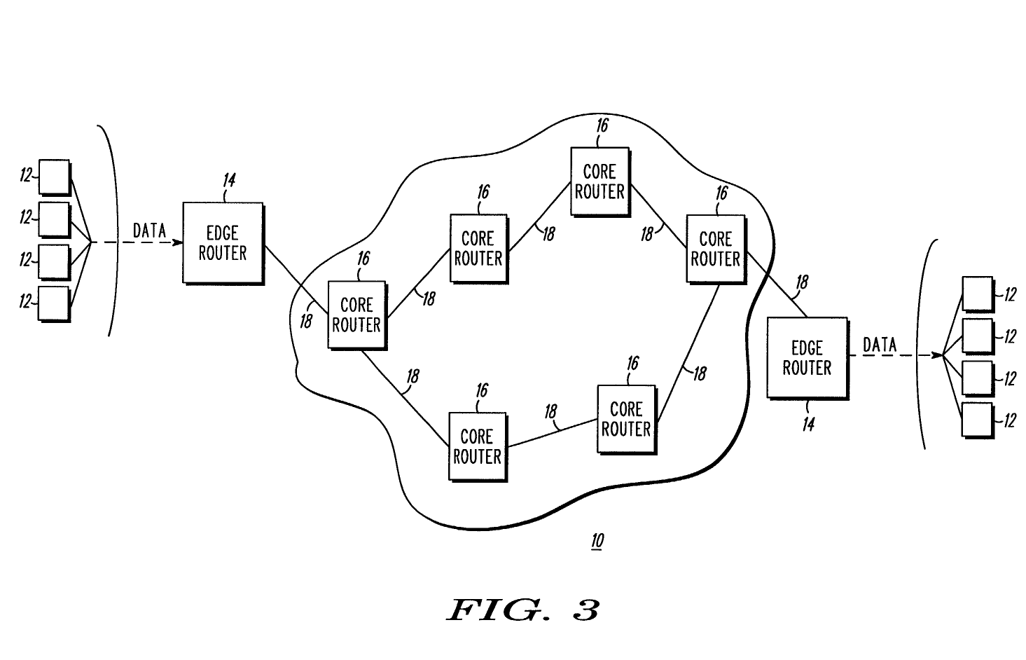

Referring to FIG. 3, the network 10 preferably consists of a plurality of end hosts 12, edge routers 14 and core routers 16, as well as a multitude of links 18 connecting the aforementioned elements. The edge routers 14 are preferably routers with end hosts 12 on one end and a core router 16 on the other end. Preferably, routers other than edge routers 14 are core routers 16. Only the ingress edge router 14 maintains state information corresponding to every flow that originates within the edge network. The edge router 14 supplies information to the core routers 16 regarding the utility function of a flow through a field within the packet header (i.e., labeling). A core router 16, which has no per-flow state information, preferably implements an algorithm, as described below, that uses this information, provided by the edge router 14, to make forwarding decisions. Thus, the edge routers 14 and the core routers 16 work in tandem to compute and maintain per-flow rate allocations for all flows.

The following sections more fully describe the present invention and the context of the invention, including its associated algorithms, implemented at both the core router 16 and the edge routers 14.

The distributed framework that approximates the rate allocations computed by a centralized algorithm that has information about the path and utility function of the flows contained within the network is described. In the present invention, only the edge routers 14 maintain per-flow state. The core routers 16 do not perform any per-flow classification or processing, and, consequently, maintain simple forwarding behavior characteristics. As a result, the distributed framework includes two concepts. First, an ingress edge router 14 logically divides a flow into substreams of different incremental utility values. The incremental utilities of these substreams correspond to the different slopes in the utility function of the flow. Substreaming is preferably done by appropriately labeling the header of the packets using the incremental utility—derived from the utility function. In the second concept, a core router 16 treats the incremental utilities stamped on the packet headers as priorities. The core router 16 then accepts (or drops) the packets based on those priorities. As a general rule, the core router 16 does not drop a packet with a higher priority packet (or higher incremental utility) as long as it can drop a lower priority packet in the queue of packets. In the present invention, the core router 16 attempts to provide the same forwarding behavior of a switch implementing a multi-priority queue, using a simple FIFO scheduling mechanism, eliminating any need for sorting the queue. Without loss of generality, a core router, in order to serve one or more output links, may have multiple output queues, each of which implements the present invention. For simplicity, the algorithm of the present invention will be explained using a piecewise linear utility function (as shown in Line U3 in FIG. 1).

The ingress edge router 14 maintains the utility function, U(r), and the current sending rate, r, corresponding to each flow the edge router 14 serves. The current sending rate of a flow can be estimated via some well-known rate estimation means. The edge router algorithm preferably labels the packet header using the field as an incremental utility uᵢ, which divides a flow into i substreams of different incremental utilities. The variable i refers to the number of regions in the utility function from O to r. It should be noted that a particular region within a piecewise linear function refers to a region of resource values with the same utility function slope. In any event, the us field is set to (U(rᵢ)−U(rᵢ₋₁))/(rᵢ−rᵢ₋₁). The variable uᵢ preferably represents the particular increment in the utility that a flow derives per incremental unit of bandwidth allocated to the flow. Thus, the substreams have pieces of the utility function of the flow embedded within them.

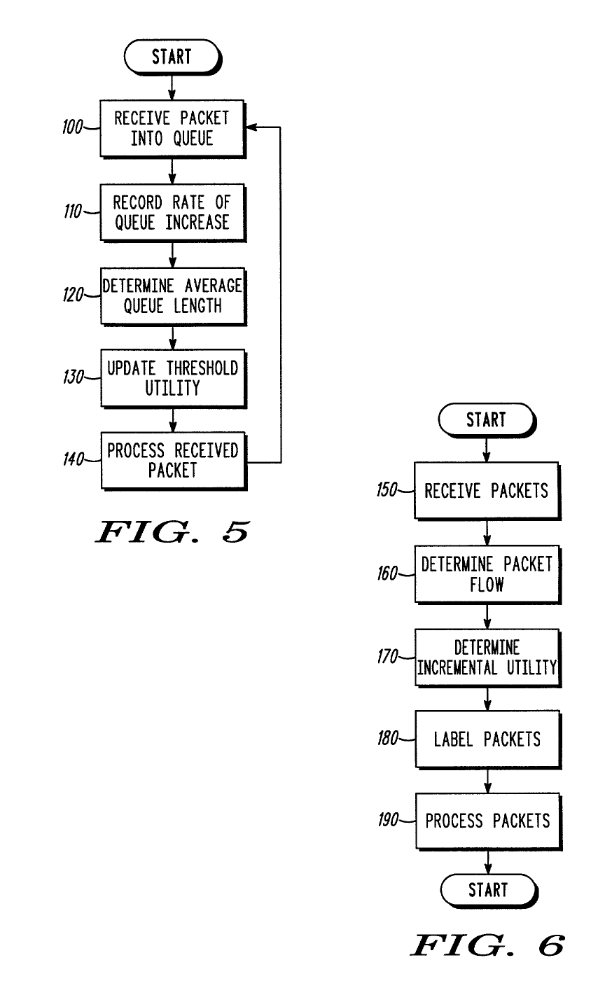

Referring to FIG. 5, a block diagram for a preferred embodiment of a method for operating a core router 16 is provided. Generally speaking, the system provides a method for operating a core router that provides multiple levels of service to packets. The core router receives packets from input links, and accepts or drops them based on the level of congestion in the outgoing link it is destined for. The level of congestion is determined by comparing the queue length of the output queue of the link with a configurable maximum queue length, and by comparing the rate at which the queue length is increasing with a configurable maximum rate of queue length increase. A threshold value is computed based on the above measurements, and this value is updated periodically based on the level of congestion in the system.

In Block 100, the core router 16 receives a packet into a queue. Preferably, the packet is transmitted from the edge router 14. This transmission is done after the edge router 14 divides each packet it receives into a rate interval, and labels each of the packets with an incremental utility value based on the substream partitioning, as described above. This incremental utility value is preferably inserted into the packet as part of a packet header. Thus, when the packet is received by the core router 16, the packet includes a packet header. This packet header contains the packet's incremental utility value.

Preferably, the core router 16 accepts packets in a way such that a packet with a higher incremental utility value is not dropped as long as a packet with a lower incremental utility can instead be dropped. Such a dropping policy ensures that, at any given core router 16, the aggregate incremental utility, Σuᵢ, of the accepted packets is maximized.

As an example, assume that the core router 16 includes a queue. The queue contains five packets. Each of the five packets contains a packet header. Each packet header further includes an incremental utility value. Finally, assume that the incremental utility factors of the five packets are 1, 2, 3, 4 and 5, respectively.

One possible solution is to maintain the queue in the core router 16 such that the queue is maintained in a decreasing order of priorities. This solution is preferably in addition to the FIFO queue, which is required to avoid any reordering of packets. When the queue size reaches its maximum limit, the lowest priority packet in the queue can therefore readily be dropped and an incoming packet may be inserted appropriately.

The above-described dropping policy can be approximated by the problem of determining a threshold value that a packet's incremental utility must have in order for the core router to forward the packet. This is called the threshold utility, uₜ. Preferably, the threshold utility may be defined as the minimum incremental utility that a packet must contain for the packet to be accepted by the core router.

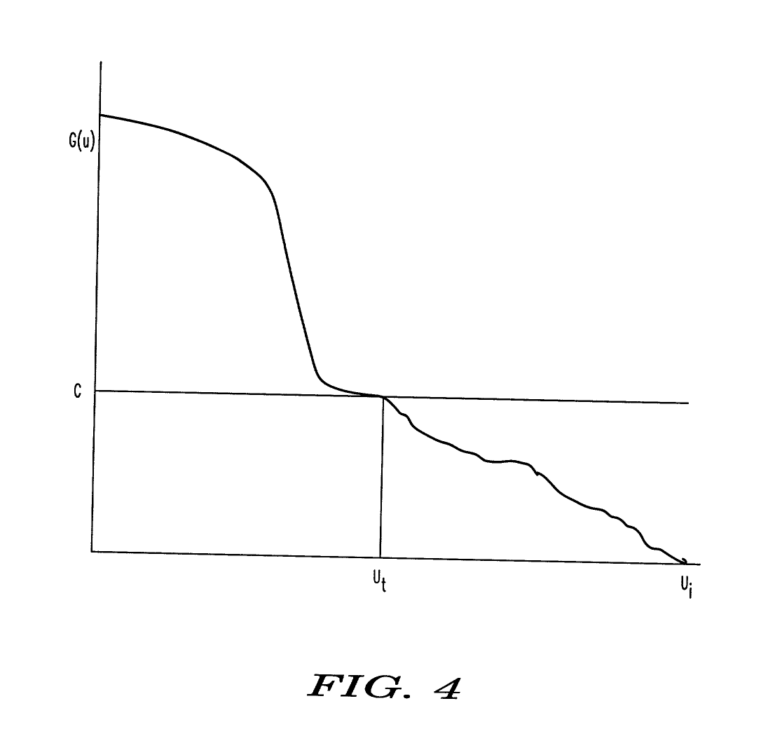

In FIG. 4, G(u) is a monotonically decreasing function of the incremental utility u. G (uᵢ)=R (u≧uᵢ), where R (uₓ) is the rate of packets entering an output link with an incremental utility label of uₓ. The threshold utility, uₜ, is that value of uᵢ which satisfies the condition G(uₜ)=C, where C is the capacity of the output link. Note that for a given G(u), there may not exist a solution to G(u)=C because of discontinuities in G(u). Also, note that the function G(u) changes with time, as flows with differing utility functions enter and leave the system and when existing flows change their sending rates. Thus, exactly tracking the utility threshold would be very difficult in practice. So, in theory, an algorithm that uses the value of a threshold priority (uₜ) for making accept or drop decisions cannot hope to replicate the result obtained by an approach that involves sorting the packets using per-flow state information. Thus, an objective of the system is to obtain a reasonably close approximation of the threshold utility, such that the sum of utilities of the flows serviced by the link closely tracks the optimal value, while the capacity of the output link is fully utilized.

The algorithm for updating the threshold utility, uₜ, is run at the end of a preferably fixed size epoch, for example 100 ms. However, the epoch can be adapted based on the network load. For example, the epoch can be based on the rate at which the queue size is increasing. Thus, according to Block 110 of FIG. 5, the algorithm determines the rate at which the queue size is increasing (grate). Furthermore, according to Block 120 of FIG. 5, the algorithm determines the average queue length (avq_q_length). This determination can be made using currently known methods of determining the mean size of a queue, which may be, for example, adding each of the lengths of the queue at different intervals, and dividing by the number of lengths.

Thus, within the algorithm, there are at least two components. The first component determines whether to increase, decrease or maintain the current value of uₜ. The second component determines the quantum of change that will be applied to increase or decrease the threshold utility. Among the factors that determine these components are the current and the average values of the queue length and the rate at which the queue is increasing. Preferably, the average queue length is computed (as provided for in Block 120) using an exponential averaging method on every dequeue event, so that:

avg_q_{—}ien=(1−e^{-D}) cur_{—}q_{—}ien +e^{-D}avg_{—}q_{—}ien,

where D is the time between successive dequeue events. The rate, qrate, at which the queue is increasing in any epoch, is preferably computed using virtual queue lengths (as provided for in Block 110). A virtual queue length is preferred so that even when the real queue is overflowing, the value of qrate reflects the difference between the number of packets accepted given the current value of uₜ, and the maximum number of packets that can be served by the router, in any given epoch. This virtual queue length is maintained by using a value that is increased by the size of every packet received with a label greater than uₜ, and decreased by the size of each packet transmitted from the queue. This value of the virtual queue length can deviate from the actual queue length during periods of severe congestion. It is resynchronized with the actual queue length when the congestion recedes. The queue rate in any given epoch is the difference between the virtual queue length at the start and the end of the epoch divided by the length of the epoch.

After making the determination as to the quantum of change that will be applied to increase or decrease the threshold utility, from Blocks 110 and 120, the algorithm then updates the threshold utility, as shown in Block 130. As described above, this process increases (or decreases) the threshold value, uₜ, for accepting packets based on the level of congestion in the queue.

Another objective of the system is to maintain the queue length between an upper threshold queue length qᵤₜₕ, and a lower threshold queue length qᵢₜₕ, and to maintain a maximum threshold utility uₜ such that the sum of the utilities of the accepted packets is as close to the maximum value as possible for the given link capacity. When there is a sudden change in G(u) (which may be due to a sudden burst of packets—i.e., a shift towards the right side, as shown in FIG. 4), there may be a rapid increase in queue size. In such a scenario, the increment factor, α, has to be large so that uₜ may be permitted to increase rapidly. However, when uₜ is hovering around the correct value, the increment factor should be small. Adjusting the value of a in this fashion significantly reduces the chance of tail drops (that is, dropping packets at the tail of the queue due to queue overflow), even when the system changes very fast. Additionally, it ensures that during the steady state, the value of uₜ is maintained at points very close to the desired value. This leads to a stable system operating at close to the optimal point of operation.

In the algorithm listed below, which illustrates a preferred embodiment for operating a core router 16, the following abbreviations are used:

Threshold Utility—uₜ

Average of labels of all accepted packets—avg_acc_u

Rate of queue increase—qrate

Current queue length—cur_q_ien

Average queue length—avg q_ien

Maximum queue size—qₗᵢₘ

Upper queue threshold—qₜₕ

Lower queue threshold—qᵢₜₕ

Increment factor—α

Decrement factor—β

Threshold change factor—changep

Increasing rate threshold—Kqi

Decreasing rate threshold—Kqd

Increment scale factor—inc

Decrement scale factor 1—dec1

Decrement scale factor 2—dec2

Thus, the algorithm for computing the threshold is as follows:

/* Update threshold */
if ((avg_q_len > qₜₕ) or (qrate > Kqi))

changep = α

else if (avg_q_len ≦ qₗₜₕ) or (qrate ≦ −Kqd)

changep = −β

else changep = 0
uₜ + = changep
/* Update α and β */
epochs_left = (qₗᵢₘ− cur_q_len)/qrate
α = inc*(avg_acc_u − uₜ)/epochs_left
if (qrate ≦ −Kqd)

β = dec1* uₜ

else

β = dec2* uₜ

In the above algorithm, the preferred values for inc, dec1, and dec2 are 1.0, 0.02, and 0.01 respectively. The average of labels of all accepted packets, avg_acc_u, is calculated by finding an average, such as exponential averaging. Preferably, the decision on whether to accept or drop a packet is made dependent whether the core router 16 is in a congested or an uncongested state. If the core router 16 is in an uncongested state, both the current and the average queue lengths are less than the lower threshold. The packet is then accepted. If the core router is in a congested state, and if u≧uₜ, the packet is still accepted. In all other instances, the packet is dropped. The pseudo code for determining whether to accept or drop a packet is given below (as provided for in Block 140). This processing may additionally include forwarding or dropping the received packet.

/* Accept or deny packet */
if ((cur_q_len < qₗₜₕ) and (avg_q_len ≦ qₗₜₕ))

Accept (pkt)

else if ((uᵢ ≧ uₜ) and (cur_q_len < qₗᵢₘ))

Accept (pkt)

else

Drop (pkt)

Returning to the example, assume that the threshold value is updated to the value of 3. In such a case, the core router 16 would then let three of the five received packets through the core router. That is, the core router 16 would accept all the three packets with a priority value of three or more (i.e., the packets with the priority value of 3, 4 and 5).

In addition to maximizing aggregate utility at every core router 16, the approach detailed in the above algorithm may alternatively be used to maximize the aggregate utility of the users in the network (i.e., to maximize Σuᵢ (rᵢ) for i=1 to N). To achieve this, after the core router 16 accepts a packet, the core router 16 decrements the uᵢ label in the packet header by the current value of the threshold utility, u_{t,}. This ensures that the packets traveling multiple hops have enough incremental utility to satisfy the sum of the thresholds of each individual hop. If all flows perform rate adaptation to network bandwidth received, a scheme such as the one described, can result in the optimum allocation that maximizes the aggregate utility of the users in the network.

The process described with regards to FIG. 5 is repeated every time a packet is received. Alternatively, the step of updating the threshold may be done in accordance with a time interval. This time interval may be periodic, or may be based on the level of network loading.

In addition to determining the threshold utility level, the core router 16 can be configured to broadcast the threshold utility value on downlink channels to announce the threshold utility level for corresponding uplink channels. This arrangement can be used in wireless systems, where the core router 16 is included in a base station and the threshold utility values are broadcast to mobile hosts. In this manner, the mobile hosts can be alerted in advance to congestion levels at the base station, prior to transmission. Based on the value of the threshold utility, the hosts can choose to either drop ahead of time packets that have a lower incremental utility value, or choose to delay their transmission and instead contend for the channel for transmission of packets with incremental utilities greater than the threshold value.

Referring to FIG. 6, a method for operating an edge router is provided. In Block 150, the edge router receives a plurality of packets. In Block 160, a packet flow is determined by the edge router. Determining the packet flow involves identifying which packets in the plurality of received packets belong to specific individual flows, as indicated by identification fields on the packet. Next, the rate of packet flow is recorded according to an exponential averaging algorithm. Any method that maintains the ability to record a rate of entry of a packet flow may be used in this step.

In Block 170, the edge router determines an incremental utility for each of the plurality of packets. Preferably, the incremental utility is determined by determining the slope of a graph of the utility function versus the bandwidth of a particular packet. The utility function can correspond to the packet flow, and can be stored locally at the edge router, or obtained from a network server or an end host. Also, the incremental utility can be determined as a function of an intra-flow priority corresponding to each of the packets.

The intra-flow priority can be based on the content of a packet. The content can correspond to a TCP retry state, a control packet, and a data packet. Alternatively, the intra-flow priority can be based on the reliability of the packet or the sensitivity of the order of dropping packets in the flow.

The incremental utility can also be based on rate intervals. To accomplish this, the edge router divides each of the plurality of packets into a rate interval based on the rate of packet flow. Preferably, the edge router first determines a rate interval. Each rate interval is preferably the distance between differing bandwidth points on the flow's utility function, where the slope of the utility function changes. That is, a rate interval corresponds to a region of constant incremental utility. For example, with reference to FIG. 1, curve U3, assuming bandwidths of r1 and r2, the rate intervals would be from 0 to r1, from r1 to r2 and from r2 to x (the estimated rate of packet flow). Using the estimated rate of packet flow, the interval can be determined based on the number of packets per second that belong to each of the rate intervals and a given packet size. Alternatively, by defining a time interval termed an epoch, the estimated rate can be determined based on the number of packets in the epoch, and the packet size.

In Block 180, the edge router labels each of the plurality of packets with a label value. The label can be proportional or equal to the incremental utility. Also, the label can be proportional to the incremental utility combined with a stability factor.

The label value may also be based on the rate interval. Preferably, a label corresponds to the particular rate interval in which a particular packet is located. For example, on packets that are less than or equal to the first rate interval, the label (i.e., label value) may be one. On packets that are between the first rate interval and the second rate interval, inclusive, the label may be two.

The packet labeling may also correspond to one or more layers of encoding. The encoding can be MPEG encoding, RLM encoding, or the like.

In Block 190, the edge router processes the packets by placing each of the packets (with their associated labels) into a queue. The edge router then further processes the packets in the queue according to the process described by FIG. 5.

It should be appreciated that the embodiments described above are to be considered in all respects only illustrative and not restrictive. The scope of the invention is indicated by the following claims rather than by the foregoing description. All changes that come within the meaning and range of equivalents are to be embraced within their scope.

We claim:

1. A method of operating an edge router, comprising:
receiving a plurality of packets;
determining a flow corresponding to the plurality of packets;
determining an incremental utility for each of the packets;
labeling each of the packets with a label as a function of the incremental utility; and
processing each of the packets based on the label.

2. The method of claim 1, wherein the step of determining the incremental utility includes:
obtaining a utility function corresponding to the flow;
determining an intra-flow priority corresponding to each of the packets; and
determining the incremental utility based on the utility function and the intra-flow priority.

3. The method of claim 2, further comprising:
obtaining the utility function from a device selected from the group consisting of a network server and an end host.

4. The method of claim 2, wherein the utility function is stored in the edge router.

5. The method of claim 2, further comprising:
calculating the utility function based on a rule corresponding to one or more incremental utilities that are sequential integers.

6. The method of claim 2, wherein the intra-flow priority is based on packet labeling.

7. The method of claim 6, wherein the packet labeling corresponds to one or more layers of encoding.

8. The method of claim 7, wherein the encoding is selected from the group consisting of MPEG encoding and RLM encoding.

9. The method of claim 2, wherein the intra-flow priority is based on the content of a packet.

10. The method of claim 9, wherein the content is selected from the group consisting of a TCP retry state, a control packet, and a data packet.

11. The method of claim 2, wherein the intra-flow priority is based on the reliability of the packet.

12. The method of claim 2, wherein the intra-flow priority is based on the sensitivity of the order of dropping packets in the flow.

13. The method of claim 2, further comprising:
partitioning the utility function into a plurality of rate intervals.

14. The method of claim 13, wherein each of the rate intervals represents a region of constant incremental utility.

15. The method of claim 1, further comprising:
partitioning the flow into a plurality of rate intervals; and
determining the incremental utility based on the rate intervals.

16. The method of claim 15, wherein the step of partitioning includes:
estimating the rate of the flow; and
determining the number of packets per second that belong to each of the rate intervals based on at least one estimated rate and at least one packet size.

17. The method of claim 15, wherein the step of partitioning includes:
estimating the rate of the flow; and
determining the number of packets per second that belong to each of the rate intervals based on an epoch length and a packet size.

18. The method of claim 15, further comprising:
calculating the incremental utility corresponding to each of the rate intervals assigned to a packet and based on a utility function.

19. The method of claim 1, wherein the label is proportional to the incremental utility.

20. The method of claim 1, wherein the label is proportional to the incremental utility combined with a stability factor.

21. A network router, comprising:
means for receiving a plurality of packets;
means for determining a flow corresponding to the plurality of packets;
means for determining an incremental utility for each of the packets;
means for labeling each of the packets with a label as a function of the incremental utility; and
means for processing each of the packets based on the label.

22. The router of claim 21, wherein the means for determining the incremental utility includes:
means for obtaining a utility function corresponding to the flow;
means for determining an intra-flow priority corresponding to each of the packets; and
means for determining the incremental utility based on the utility function and the intra-flow priority.

23. The router of claim 22, further comprising:
means for partitioning the utility function into a plurality of rate intervals.

24. The router of claim 22, further comprising:
means for partitioning the utility function into a plurality of rate intervals.

25. The router of claim 21, further comprising:
means for partitioning the flow into a plurality of rate intervals; and
means for determining the incremental utility based on the rate intervals.

26. A computer-usable medium storing a computer program for directing a network router to perform the steps of:
receiving a plurality of packets;
determining a flow corresponding to the plurality of packets;
determining an incremental utility for each of the packets; and
labeling each of the packets with a label as a function of the incremental utility.

27. The computer-usable medium of claim 26, wherein the step of determining the incremental utility includes:
obtaining a utility function corresponding to the flow;
determining an intra-flow priority corresponding to each of the packets; and
determining the incremental utility based on the utility function and the intra-flow priority.

28. The computer-usable medium of claim 27, further comprising:
partitioning the utility function into a plurality of rate intervals.

29. The computer-usable medium of claim 26, further comprising:
partitioning the flow into a plurality of rate intervals; and
determining the incremental utility based on the rate intervals.
